(19) United States
(12) Patent Application Publication
(10) Pub. No.: US 2025/0364808 A1
(43) Pub. Date: Nov. 27, 2025

(54) Information Processing Device

(71) Applicant: Hitachi, Ltd., Chiyoda-ku, Tokyo (JP)

(72) Inventors: Mamoru OKAMOTO, Tokyo (JP); Hiroshi UCHIGAITO, Tokyo (JP); Takashi TAKEMOTO, Tokyo (JP)

(21) Appl. No.: 18/872,475

(22) PCT Filed: Jan. 12, 2023
(86) PCT No.: PCT/JP2023/000667

§ 371 Date: Dec. 6, 2024

(30) Foreign Application Priority Data
Jul. 8, 2022 (JP) 2022-110125

(51) Int. Cl. H02J 3/00

(52) U.S. Cl. CPC H02J 3/004

(57) ABSTRACT

An object of the present invention is to appropriately evaluate a temporally and spatially distributed and fluctuating electric power demand pattern, and accurately estimate a location and scale at which an electric power supply base needs to be installed. An information processing apparatus according to the present invention transforms electric power demand information into a demand function on a spatial axis, generates an integral kernel for evaluating a required supply amount, and estimates an installation location or required scale of an electric power supply point from a result of performing convolution on the demand function and the integral kernel.

### TECHNICAL FIELD

The present invention relates to a technique for estimating a location and scale at which an electric power supply base that needs to be installed.

### BACKGROUND ART

As means for supplying renewable energy, nanogrids are being developed. A nanogrid is an electric power base station that supplies electric power in a local geographical region. The location where the nanogrid is installed and its scale of electric power supply need to be appropriately determined according to a demand for electric power and electric power supply means other than the nanogrid. In order to implement stable supply of electric power, especially in a region where points at which electric power is demanded are dispersed, it is necessary to appropriately grasp a spatial distribution and a temporal fluctuation of a demand for electric power. An example of means for distributing electric power supplied from the nanogrid is a method using a vehicle having a battery installed therein, such as an electric vehicle.

The following Patent Literature 1 describes a technique in which “model generation means uses the amount of electric power procured from each of a plurality of electric power procurement means as an operational variable, uses a value including the total cost required to procure the amount of electric power corresponding to a predicted demand using the plurality of electric power procurement means as an objective function, and generates an optimization model having a constraint regarding the amount of electric power that can be procured from the electric power procurement means, and determination means solves the optimization model using a mathematical optimization method to determine an electric power procurement plan that indicates the amount of electric power to be procured from each of the plurality of electric power procurement means” based on an issue that “an electric power procurement plan that can be adapted to any demand scenario with the premise of replanning is created” (refer to Abstract).

### CITATION LIST

### Patent Literature

Patent Literature 1: Japanese Unexamined Patent Application Publication No. 2021-157724

### SUMMARY OF INVENTION

### Technical Problem

In preparation for the shortage of an electric power transmission capacity caused by the introduction of a large amount of renewable energy, it is effective to combine a self-contained nanogrid that does not rely on an existing electric power distribution network and electric power distribution using an electric vehicle. However, in distribution of electric power using the electric vehicle, there is a time lag until electric power is supplied to a point at which electric power is demanded. Further, the electric vehicle itself consumes electric power as the vehicle moves. This makes it difficult to estimate a suitable candidate location to which electric power is to be supplied. It is difficult for such a conventional electric power planning method as disclosed in Patent Literature 1 to adequately address such needs.

The present invention has been made in view of the above-described problems, and an object of the present invention is to appropriately evaluate a temporally and spatially distributed and fluctuating electric power demand pattern, and accurately estimate a location and scale at which an electric power supply base needs to be installed.

### Solution to Problem

An information processing apparatus according to the present invention transforms electric power demand information into a demand function on a spatial axis, generates an integral kernel for evaluating a required supply amount, and estimates an installation location or required scale of an electric power supply point from a result of performing convolution on the demand function and the integral kernel.

### Advantageous Effects of Invention

According to the information processing apparatus according to the present invention, by appropriately evaluating a temporally and spatially distributed and fluctuating electric power demand pattern, it is possible to accurately estimate a location and scale at which an electric power supply base needs to be installed. Other issues, configurations, effects, and the like of the present invention will become clear from description of embodiments below.

### BRIEF DESCRIPTION OF DRAWINGS

FIG. 1 is a configuration diagram of an information processing apparatus 1.

FIG. 2 illustrates a configuration of electric power demand information and an example of data.

FIG. 3 illustrates a configuration of electric power supply means information and an example of data.

FIG. 4 illustrates a configuration of electric power supply base information and an example of data.

FIG. 5 is a PAD for explaining a procedure for estimating a candidate point for an electric power supply base by the information processing apparatus 1.

FIG. 6 is a PAD for explaining details of S502.

FIG. 7 is a PAD for explaining details of S504.

FIG. 8 is a graph illustrating examples of an integral kernel generated in S504.

FIG. 9 illustrates an example of convolution performed by a convolution unit 13.

FIG. 10 illustrates an example of an estimation process performed by an estimation unit 14.

FIG. 11 illustrates another example of the estimation process performed by the estimation unit 14.

FIG. 12 illustrates an example in which results of estimation by the estimation unit 14 is visualized.

### DESCRIPTION OF EMBODIMENTS

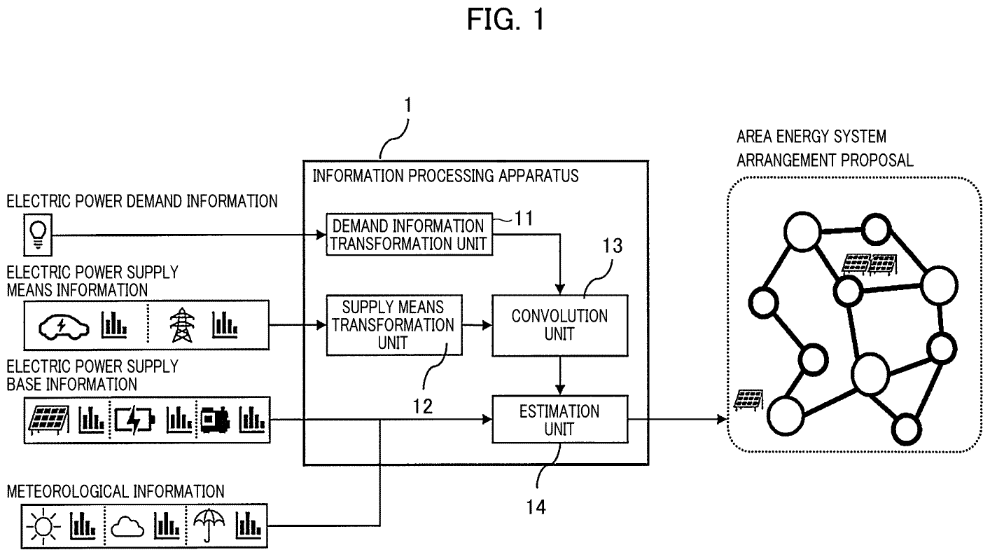

FIG. 1 is a configuration diagram of an information processing apparatus 1 according to an embodiment of the present invention. The information processing apparatus 1 is an apparatus that estimates a location at which an electric power supply base needs to be installed, and scale of supply of electric power required to be supplied. The information processing apparatus 1 includes a demand information transformation unit 11, a supply means transformation unit 12, a convolution unit 13, and an estimation unit 14.

The demand information transformation unit 11 receives electric power demand information. The electric power demand information is data in which a demand for electric power in each of regions is described for each time point. The regions can be expressed by a collection of subspaces such as polygons or can be expressed by a collection of specific spatial coordinates, as described later. The demand information transformation unit 11 transforms the electric power demand information into a demand function by using a procedure described later.

The supply means transformation unit 12 receives electric power supply means information. The electric power supply means information is data describing the supply capacity of electric power supply means (for example, a vehicle having a battery installed therein, a private line that transmits electric power generated by power generation equipment, or the like). The supply capacity corresponds to the ability to deliver electric power generated by an electric power generation base. The supply means transformation unit 12 transforms the electric power supply means information into an integral kernel by using a procedure described later.

The convolution unit 13 performs convolution on the demand function and the integral kernel. The estimation unit 14 estimates, based on a function or value obtained from a result of the convolution, a location at which an electric power supply base needs to be installed, and scale of supply of electric power required to be supplied. An example of the convolution and the estimation process will be described later.

The estimation unit 14 receives electric power supply base information and meteorological information and performs the estimation using the information. The electric power supply base information describes a supply capacity for each type of electric power supply base assumed to be newly installed. The meteorological information describes weather conditions (e.g., the amount of solar radiation, a wind speed, a wind direction, and the like) in an estimation target period. Specific examples of the information will be described later.

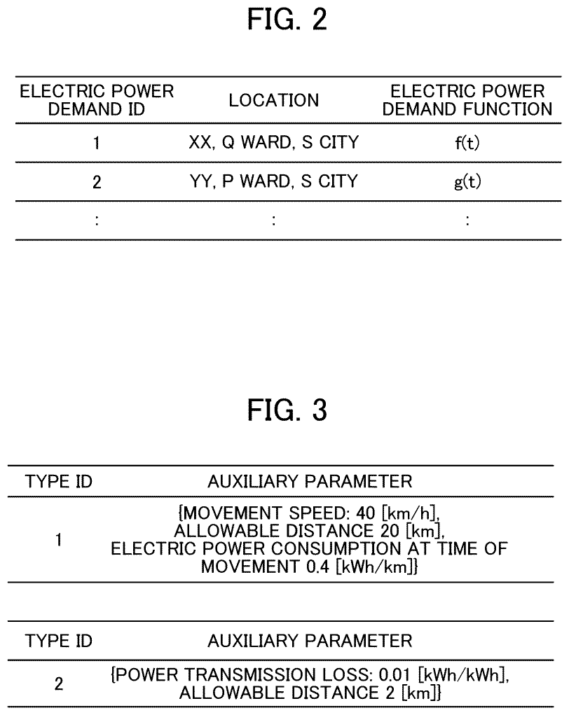

FIG. 2 illustrates a configuration of the electric power demand information and an example of data. The electric power demand information includes an electric power demand ID, a location, and an electric power demand function. The electric power demand ID is an ID identifying a geographical location where a demand for electric power occurs. In FIG. 2, IDs are serial numbers for convenience, but may be any values as long as the IDs can uniquely identify demand points. The location indicates a spatial distribution or position of a point at which a demand for electric power occurs. In the example illustrated in FIG. 2, locations are described using addresses, but in a case where the electric power demand information is transformed into a demand function, location values are replaced with polygons representing geographical divisions or coordinates of representative points, or the like. The electric power demand function is a function representing a change in the demand for electric power at the location over time.

As the form of the electric power demand function, various known methods can be used. For example, in a case where there is no need to consider changes over time, a constant function may be used. Alternatively, a function that is a constant within a specific time interval, a function using a spline curve, a piecewise linear function (a polygonal line function), or the like may be used.

FIG. 3 illustrates a configuration of the electric power supply means information and an example of data. The electric power supply means information describes, for each type of electric power supply means, an auxiliary parameter representing the power supply capacity of the type. A type ID 1 indicates a vehicle having a battery installed therein, and a type ID 2 indicates a private line that transmits electric power, such as renewable energy, generated by power generation equipment. These are an example, and similar parameters can be defined for other supply means. The supply means transformation unit 12 configures an integral kernel by applying an auxiliary parameter to a function form predetermined for each type. A specific example will be described later.

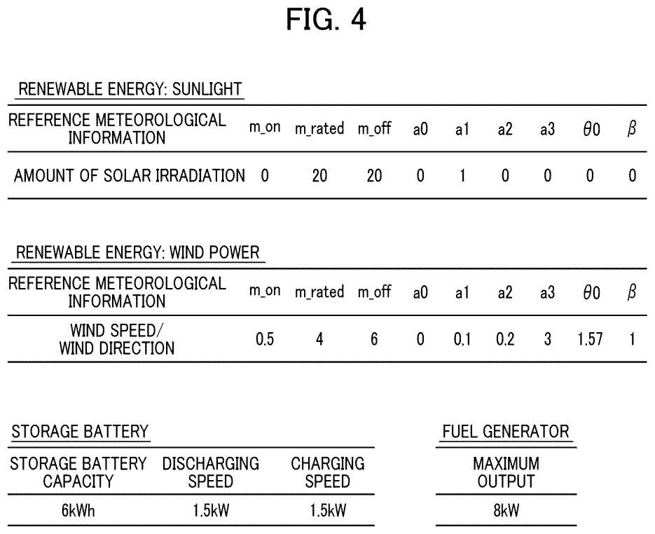

FIG. 4 illustrates a configuration of the electric power supply base information and an example of data. Examples of the type of the electric power supply base are renewable energy (solar power generation panel), renewable energy (wind power generation), a storage battery, and a fuel generator. The electric power supply base information describes parameters representing a power generation capacity for each base type. The estimation unit 14 uses these parameters to estimate a location at which a base needs to be installed and scale of the base.

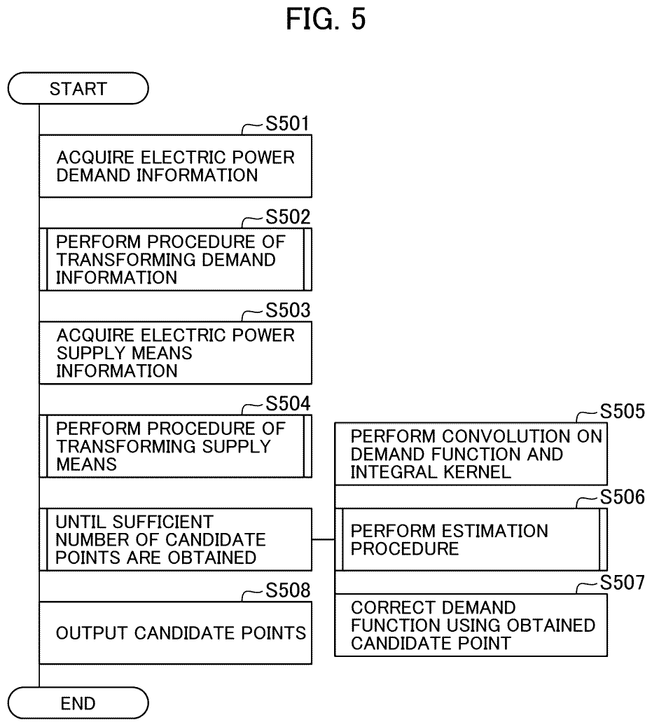

FIG. 5 is a problem analysis diagram (PAD) for explaining a procedure for estimating a candidate point for an electric power supply base by the information processing apparatus 1. Each step in FIG. 5 will be described below.

### (FIG. 5: Steps S501 and S502)

The demand information transformation unit 11 acquires the electric power demand information (S501). The demand information transformation unit 11 transforms the electric power demand information into a demand function (S502). A specific procedure of a transformation process will be described later.

### (FIG. 5: Steps S503 and S504)

The supply means transformation unit 12 acquires the electric power supply means information (S503). The supply means transformation unit 12 transforms the electric power supply means information into an integral kernel (S504). A specific procedure of a transformation process will be described later.

### (FIG. 5: Steps S505 to S508)

The convolution unit 13 performs convolution on the demand function obtained in S502 and the integral kernel obtained in S504 (S505). The estimation unit 14 estimates a location (candidate point) of the electric power supply base and scale of supply by using a procedure described later (S506). The estimation unit 14 corrects the demand function using the obtained candidate point (S507). S505 to S507 are repeated until a sufficient number of candidate points are obtained. The estimation unit 14 outputs the obtained candidate points (S508).

### (FIG. 5: Step S507: Supplement)

A single candidate point can be obtained by performing S506 once. The estimation unit 14 assumes that a demand for electric power supplied by the base installed at the candidate point is satisfied, and corrects the demand function by subtracting the satisfied portion from the demand function. The estimation unit 14 estimates a candidate base again based on the corrected demand function.

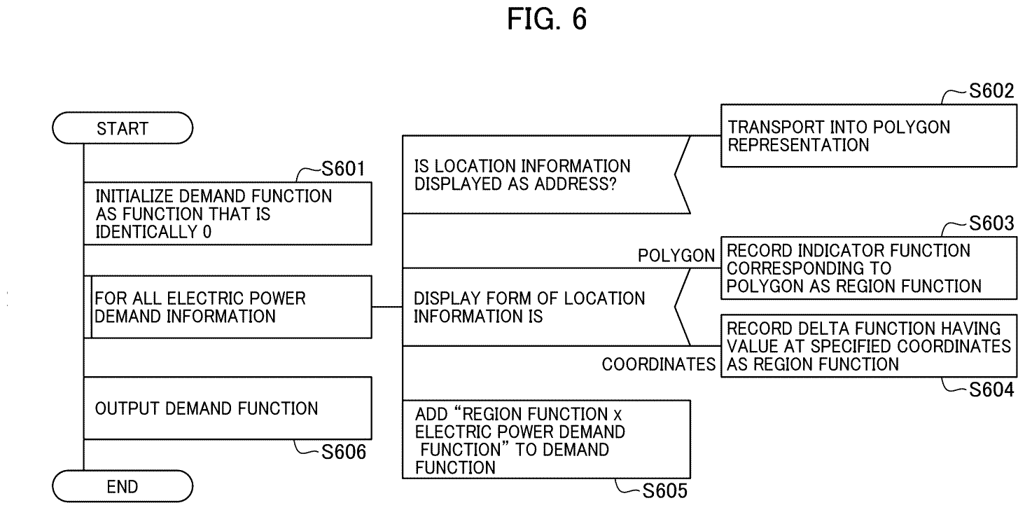

FIG. 6 is a PAD for explaining details of S502. The demand information transformation unit 11 initializes the demand function by using a function that is identically 0 (S601). In a case where the location of the electric power demand information is an address representation, the demand information transformation unit 11 transforms a location value into a polygon representation (S602). The transformation into the polygon can be performed using, for example, commercially available block polygon data. In a case where the location is a polygon representation, the demand information transformation unit 11 records an indicator function corresponding to the polygon as an area function (S603). The indicator function in this case is a function that takes 1 on a specific subset and 0 otherwise for a given domain. In a case where the location is represented by coordinates of one point, the demand information transformation unit 11 records a delta function having a value at specified coordinates as an area function (S604). The demand information transformation unit 11 linearly adds “the area function x the electric power demand function” to the demand function (S605). The demand information transformation unit 11 performs S602 to S605 on all the electric power demand information. The demand information transformation unit 11 outputs the demand function obtained in the above-described manner (S606).

The demand information transformation unit 11 calculates the area function x the electric power demand function for each polygon representing a geographical space, and linearly sums the results for all the polygons, thereby obtaining the demand function for the entire area. Even in a case where coordinates are used instead of the polygons, it is sufficient to similarly calculate the area function x the electric power demand function for each set of coordinates, and linearly sum the results for all the coordinates.

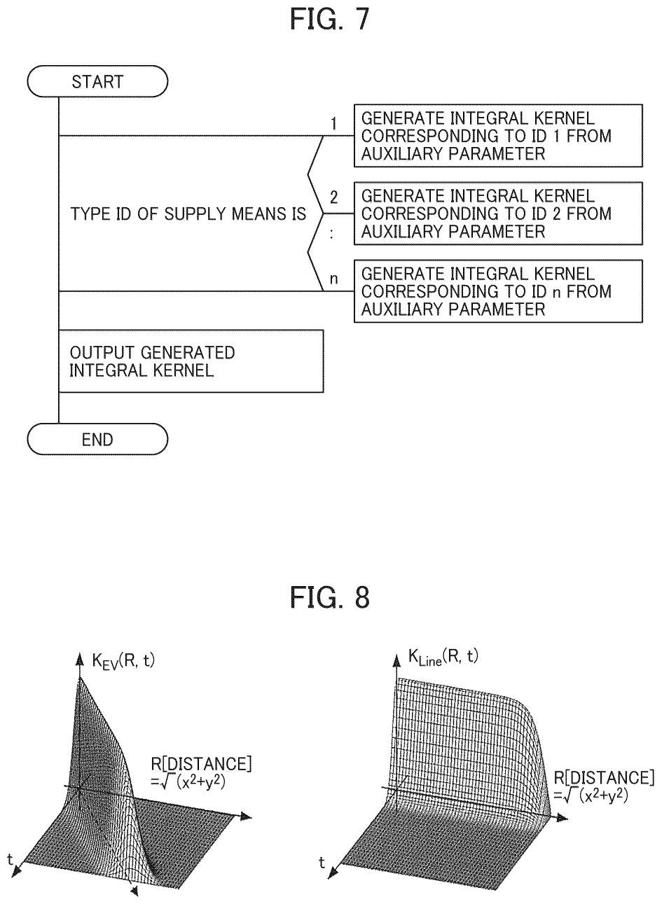

FIG. 7 is a PAD for explaining details of S504. The supply means transformation unit 12 generates an integral kernel in accordance with a function form predefined for each type ID described in the electric power supply means information. In this case, the supply means transformation unit 12 applies an auxiliary parameter for each type ID to this function form. The supply means transformation unit 12 outputs the generated integral kernel.

FIG. 8 is a graph illustrating examples of the integral kernel generated in S504. The left side of FIG. 8 illustrates an example of an integral kernel K_{EV} (R, t) corresponding to the type ID 1 in FIG. 3. The right side of FIG. 8 illustrates an example of an integral kernel K_{Line} (R, t) corresponding to the type ID 2 in FIG. 3. The origin corresponds to the central point for considering a demand for electric power.

In a case where the type ID 1 (vehicle having a battery installed therein) is electric power supply means, the longer a distance R from the center point is, the longer it takes for the vehicle to arrive. Therefore, the integral kernel representing an electric power supply capacity of the type ID 1 has a peak on a primary function (R=Vt) whose gradient indicates the movement speed V of the vehicle. However, in a case where an upper limit distance that the vehicle is allowed to travel is defined, K is 0 at the upper limit distance. In addition, since the vehicle itself consumes electric power, the supply capacity is subtracted by the amount consumed. The information can be obtained from the auxiliary parameters described in the electric power supply means information. The supply means transformation unit 12 applies these parameters to the type of the integral kernel K corresponding to type ID 1, thereby obtaining the integral kernel illustrated on the left side of FIG. 8. This integral kernel form allows a candidate point to be estimated in consideration of a future demand for electric power in a remote location.

In a case where the type ID 2 (private line) is electric power supply means, electric power is instantaneously distributed and the integral kernel has a peak at t=0. However, depending on various constraints such as the budget for wiring the private line, there may be cases where an upper limit distance over which electric power is allowed to be transmitted is stipulated. In this case, K is 0 at the upper limit distance. Further, the supply capacity is subtracted due to an electric power transmission loss. The information can be obtained from the auxiliary parameters described in the electric power supply means information. The supply means transformation unit 12 applies these parameters to the type of the integral kernel K corresponding to type ID 2, thereby obtaining the integral kernel illustrated on the right side of FIG. 8.

The actual geographical shape is not isotropic, but has various shapes for each point (or for each direction). Therefore, the integral kernel representing the supply capacity of the electric power supply means also needs to reflect the specificity of each location. In the example illustrated in FIG. 8, to simplify the explanation, the integral kernel was defined only by a distance from the origin and time without considering this specificity. Examples of the specificity are: a case where since there is a river, the vehicle cannot move to an opposite shore; a case where it takes time to move in a diagonal direction since a road extends north, south, east, and west; and the like. In a case where the integral kernel is configured in consideration of the specificity, the shape of the integral kernel may be changed to express the specificity. In order to express directional specificity, the integral kernel may have an anisotropic shape. In order to express point specificity, the shape of the integral kernel itself may be modified depending on the position.

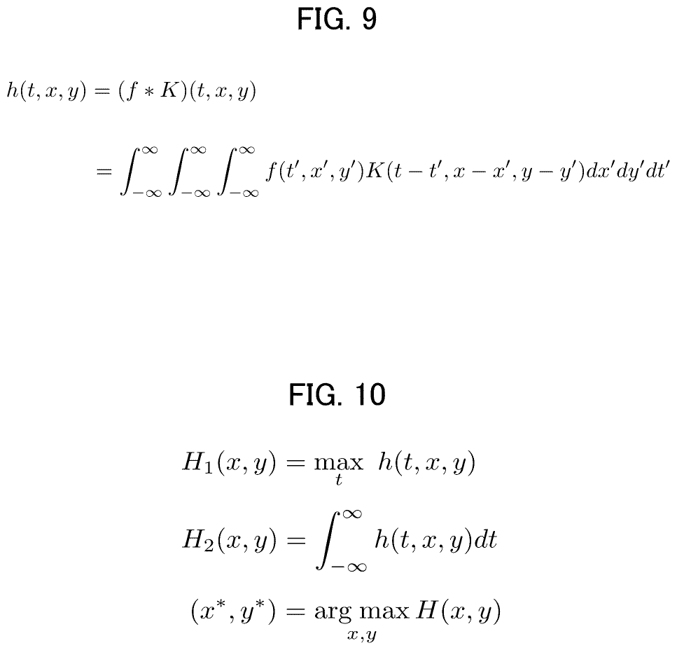

FIG. 9 illustrates an example of the convolution performed by the convolution unit 13. The convolution unit 13 obtains a function h by performing integration as illustrated in FIG. 9 on the demand function f obtained in S502 and the integral kernel K obtained in S504. x and y are geographical coordinates. tis time. In actual arithmetic processing, integration is performed within the range of finite values for each of x, y, and t.

In a case where each function is represented by a grid point and calculation is performed for each grid point, the amount of calculation may become large. Therefore, in this case, it is desirable to perform calculation similar to FIG. 9 via fast Fourier transform. However, in a case where f is a superposition of a delta function, it is considered more effective to directly calculate it. Alternatively, it is also conceivable to perform similar calculation using a system of orthogonal functions other than trigonometric functions.

A result of the convolution can be output as a value h for each grid point, for example. This is due to the fact that in a case where the number of candidate locations at which the electric power supply base is installed is small, when the value of h for each grid point is output, the estimation process can be sufficiently implemented. In a case where the number of candidate locations is small, each function may be represented by a grid point and the integration illustrated in FIG. 9 may be performed for each grid point without fast Fourier transform. This is due to the fact that the calculation load in that case is not necessarily enormous.

FIG. 10 illustrates an example of the estimation process performed by the estimation unit 14. The estimation unit 14 outputs coordinates (x*, y*) of a candidate location at which the electric power supply base is installed. However, since the function h illustrated in FIG. 9 has a value on a space-time axis, it is necessary to summarize h on the time axis in order to output a candidate spatial location. For example, the following summarization method can be used depending on the method and purpose of selecting an integral kernel. FIG. 10 explains, as an example, an estimation process in a case where the electric power supply base is a fuel generator.

h represents a certain type of amount of demanded electric power. Therefore, by determining the maximum value of h on the time axis for each set of coordinates, it is possible to estimate the scale of electric power (that is, the scale of the equipment) to be supplied by the installed electric power supply base. H1 (x, y) illustrated in FIG. 10 is an example thereof. Hl represents the required scale of the fuel generator (or the number of fuel generators).

By integrating h over a certain range on the time axis, the total amount of demanded electric power (service provision amount) during the period can be estimated for each set of coordinates. The total amount of demanded electric power is an indicator of the sales volume of the installed electric power supply base. H2 (x, y) illustrated in FIG. 10 is an example thereof. However, depending on the characteristics of the integral kernel K, it may not be appropriate to interpret the integral amount as it is as the total amount of demanded electric power during the same period. H2 represents the maximum amount of electric power that can be supplied by the installed fuel generator.

The maximum value on the time axis of a function obtained by convolving a window function having a value on the time axis with h may be calculated for each set of coordinates. For example, it is conceivable to convolve a window function that represents an expected recovery time when the power supply means fails. Thus, it is possible to calculate spare equipment and an amount of fuel that needs to be held.

The estimation unit 14 outputs, as a candidate point where the electric power supply base is installed, coordinates (x*, y*) that maximize a function obtained by summarizing h on the time axis using the above-described method. (x*, y*) illustrated in FIG. 10 are an example thereof.

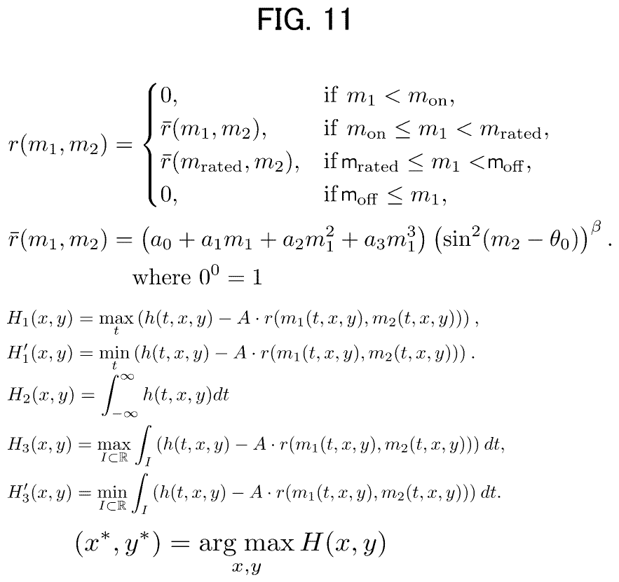

FIG. 11 illustrates another example of the estimation process performed by the estimation unit 14. FIG. 11 explains an example in a case where the electric power supply base includes a combination of renewable energy and a storage battery. A function r (m1, m2) is a function that calculates the amount of electric power generated by renewable energy from parameters such as the amount of solar irradiation, a wind speed, and a wind direction. The same function can be used in each of a case where the renewable energy is solar power generation and a case where the renewable energy is wind power generation. As numerical examples of the parameters in calculation formulas, those illustrated in FIG. 4 can be used. In the present embodiment, it is assumed that charging is performed only by the storage battery.

The estimation unit 14 refers to the amount of solar radiation in the meteorological information in order to estimate a candidate location and required scale for solar power generation. In this case, the amount of solar radiation is substitute for m1, and 0 is substituted for m2. To estimate a candidate location and required scale for wind power generation, a wind direction and a wind speed in meteorological information are referred to. In this case, the wind speed is substituted for m1, and wind light is substituted for m2. In the present embodiment, it is assumed that the wind direction is described based on an arc method such that the north is 0 and the east is 1.57. The example of the data illustrated in FIG. 4 conforms to this.

A function r⁻(m1, m2) represents the amount of electric power generation when a unit amount of renewable energy power generation equipment is introduced by a third-order polynomial. θ0 represents a decrease in the amount of electric power generation due to deviation from an expected direction. β is a parameter that controls a change in the decrease in the amount due to the deviation from the expected direction. These parameters can be determined experimentally or from designed values.

In the present embodiment, the wind power generation equipment is assumed to be a horizontal axis type wind power generation equipment with a fixed propeller. By setting β=1, a change in the amount of electric power generation due to the difference between the expected direction and the wind direction is represented. Even in a case where the propeller is of a horizontal axis type, in a case where the propeller follows a change in the wind direction, or in a case where a vertical axis type wind turbine is used, the effect of the wind direction can be ignored by setting β=0.

By using H1, it is possible to estimate the discharging speed of the storage battery and the output of the fuel generator required to compensate for insufficient output when an A unit of renewable energy equipment is introduced. By using H1′, it is possible to estimate the charging speed of the storage battery required to absorb excess renewable energy. As in the case of the fuel generator (not including renewable energy and a storage battery), the maximum amount of electric power that can be supplied can be estimated by using H2.

By using H3, it is possible to estimate the largest excess amount of demanded electric power in a continuous time period. By using this value, it is possible to estimate the required capacity of the storage battery and the capacity of a tank of the fuel generator. Since discharge can be performed by both the storage battery and the fuel generator, the sum of these two is important. By using H3′, it is possible to estimate the largest excess amount of renewable energy in a continuous time period. By using this value, it is possible to estimate the required capacity of the storage battery.

The estimation unit 14 outputs coordinates (x*, y*) that maximize the function H obtained by the above-described method as a candidate point for the power supply base to be installed. (x*, y*) illustrated in FIG. 11 are an example thereof. The estimation unit 14 estimates a candidate point for each type of electric power supply base by implementing the estimation procedure described in FIG. 10 or 11 for each type of electric power supply base.

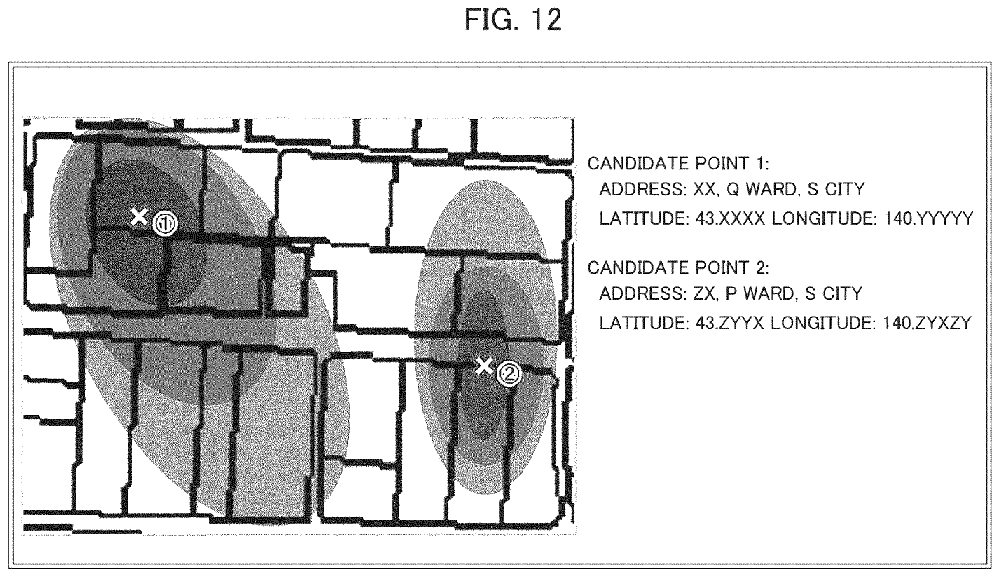

FIG. 12 illustrates an example in which results of the estimation by the estimation unit 14 are visualized. The estimation unit 14 can display results of the visualization as illustrated in FIG. 12 on a display, for example, or output data describing the results of the visualization. An ellipse in FIG. 12 is represented as a heat map that summarizes results (h (t, x, y)) of calculation by the convolution unit 13 on the time axis. Candidate points for installation of the electric power supply base are represented by x marks. The right side of FIG. 12 illustrates coordinates of the candidate points by latitudes, longitudes, and addresses. By using the map as illustrated in FIG. 12, it is possible to visually present the amount of electric power required to be supplied.

### <Regarding Modifications of Present Invention>

The present invention is not limited to the above-described embodiments and includes various modifications. For example, the above-described embodiments have been described in detail to explain the present invention in an easy-to-understand manner, and are not necessarily limited to those having all the configurations described. In addition, it is possible to replace a part of the configuration of one embodiment with the configuration of another embodiment, and it is also possible to add the configuration of another embodiment to the configuration of one embodiment. Further, regarding a part of the configuration of each embodiment, addition, deletion, and replacement of another configuration can be made.

In the above-described embodiments, the functional units included in the information processing apparatus 1 can also be configured with hardware such as a circuit device that implements these functions, and can also be configured by a computing device such as a central processing unit (CPU) executing software that implements these functions.

### LIST OF REFERENCE SIGNS

1: information processing apparatus
11: demand information transformation unit
12: supply means transformation unit
13: convolution unit
14: estimation unit

1. An information processing apparatus that estimates an installation location or required scale of a supply point from demand information with spatial spread and supply means, the information processing apparatus comprising:
a demand information transformation unit that receives the demand information and transforms the demand information into a demand function defined in a space;
a supply means transformation unit that generates an integral kernel that is a function for evaluating a required supply amount based on an amount of a supply loss based on a distance from the supply point to a demand point;
a convolution unit that performs convolution on the demand function and the integral kernel; and
an estimation unit that estimates, from a result of the convolution, a plurality of installation locations or required scale of the supply point.

2. The information processing apparatus according to claim 1, wherein
the demand information transformation unit specifies a first indicator function representing a demand for electric power by a function describing the demand for electric power for each subspace at each time, and
the demand information transformation unit configures the demand function by specifying the first indicator function for all the subspaces and linearly adding the first indicator function.

3. The information processing apparatus according to claim 1, wherein
the demand information transformation unit specifies a second indicator function representing a demand for electric power by a function that describes the demand for electric power for each set of spatial coordinates at each time in a form of a product of a delta function and a time-varying function, and
the demand information transformation unit configures the demand function by linearly adding the second indicator function for all the spatial coordinates.

4. The information processing apparatus according to claim 1, wherein
the supply means transformation unit configures the integral kernel using a parameter representing a characteristic of the supply means.

5. The information processing apparatus according to claim 4, wherein
the supply means is a vehicle having a battery installed therein,
the parameter is at least one of a movement speed of the vehicle, an upper limit distance that the vehicle is allowed to move, and an amount of electric power in the battery that is consumed as the vehicle moves, and
the supply means transformation unit configures the integral kernel using a function representing a supply capacity of the supply means in accordance with the parameter.

6. The information processing apparatus according to claim 5, wherein
a function constituting the integral kernel has a peak at the upper limit distance, and represents an ability of the vehicle to deliver electric power.

7. The information processing apparatus according to claim 4, wherein
the supply means is a private line that transmits energy generated by power generation equipment,
the parameter at least one of a power transmission loss due to the energy transmission by the private line, and an upper limit distance over which the private line is allowed to transmit the energy, and
the supply means transformation unit configures the integral kernel using a function representing a supply capacity of the supply means in accordance with the parameter.

8. The information processing apparatus according to claim 7, wherein
a function constituting the integral kernel has a peak at a time of zero on a time axis, has a non-zero value only within a predetermined range from an origin on a distance axis, and represents an ability of the power generation equipment to deliver electric power.

9. The information processing apparatus according to claim 1, wherein
the estimation unit calculates a function that represents a change on a time axis of a result function obtained from the result of the convolution, and
the estimation unit specifies, as a candidate for the installation location, spatial coordinates that maximize a function representing a change in the result function on the time axis.

10. The information processing apparatus according to claim 9, wherein
the estimation unit calculates a maximum value of the result function over all times for each set of coordinates on a spatial axis, and
the estimation unit estimates the required scale for each set of the coordinates based on the maximum value for each set of the coordinates.

11. The information processing apparatus according to claim 9, wherein
the estimation unit calculates an integral value obtained by integrating the result function over all times for each set of coordinates on a spatial axis, and
the estimation unit estimates the required scale for each set of the coordinates by estimating a total amount of demanded electric power for each set of the coordinates based on the integral value for each set of the coordinates.

12. The information processing apparatus according to claim 9, wherein
the estimation unit performs second convolution by further convolving a window function configured only within a specific time range with the result function,
the estimation unit calculates a second maximum value of a function obtained from a result of the second convolution over all times for each set of coordinates on a spatial axis, and
the estimation unit estimates the required scale for each set of the coordinates based on the second maximum value for each set of the coordinates.

13. The information processing apparatus according to claim 1, wherein
the estimation unit receives base information that describes a parameter representing a power generation capacity of the supply point where an amount of electric power generation fluctuates depending on weather,
the estimation unit receives meteorological information that describes a weather fluctuation,
the estimation unit calculates an amount of electric power that can be generated by the supply point according to the weather fluctuation described in the meteorological information, and
the estimation unit estimates a candidate for the installation location in accordance with the result function obtained from the result of the convolution and the calculated amount of electric power generation.

14. The information processing apparatus according to claim 1, wherein
the estimation unit outputs a view in which a result of the estimation is described on a two-dimensional map.
